(19) United States
(12) Patent Application Publication
(10) Pub. No.: US 2007/0029817 A1
(43) Pub. Date: Feb. 8, 2007

(54) Safety lock

(76) Inventor: Roland Svensson, Mellbystrand (SE)

Correspondence Address: BIRCH STEWART KOLASCH & BIRCH, PO BOX 747, FALLS CHURCH, VA, 22040-0747, US

(21) Appl. No.: 10/549,702

(22) PCT Filed: Mar. 19, 2004
(86) PCT No.: PCT/SE04/00410

§ 371 Date: Sep. 5, 2006

(30) Foreign Application Priority Data
Mar. 20, 2003 (SE) 0300750-7

(51) Int. Cl. E05C 17/04

(52) U.S. Cl. 292/262

(57) ABSTRACT

The invention relates to a safety lock (1) for opening members (2), such as doors and windows, comprising a stop shoulder (3) arranged adjacent to the frame (4) of the door, a locking means (5) arranged adjacent to the door (2) and movable along the plane of the door, and movingly overlapping the stop shoulder (3). The locking means (5) is operable at least from the inside of the door (2), said locking means (5), having a locked position, a safety position and an open position. Said locking means (5) constitutes both lock and limitation for the opening movement of the door. The end part (6) of the locking means is, when the locking means (5) is in its safety position, movable a limited distance perpendicular to the plane of the door. The end part (6) of said locking means engages an abutment means (7) arranged adjacent to the frame (4) and thus limits the opening movement of the door. The end part (6) of the locking means is, when the locking means (5) is in its locked position, rigidly connected to the remaining part of the locking means (5) and overlaps said stop shoulder, said locking means (5), in its open position, being moved from its position overlapping said stop shoulder (3).

### FIELD OF THE INVENTION

The present invention relates to a safety lock for opening members, such as doors and windows, comprising a stop shoulder arranged adjacent to the frame of the door, a locking means arranged adjacent to the door and movable along the plane of the door, and movingly overlapping the stop shoulder. The locking means is operable at least from the inside of the door, said locking means having a locked position, a safety position and an open position.

### BACKGROUND ART

Opening members, such as doors and windows, can sometimes be provided with safety components such as safety chains or safety braces. These safety components can be connected to a fastener in the frame, which allows the door to open a limited and predetermined distance.

Such safety components are used, for example in a safety position, to allow a door to be partly opened and a person on the outside of the door to be viewed. To allow him access, the safety component is disconnected from the frame, whereby the door can be fully opened.

However, there are several problems in connection with safety components of this type. The existing safety components have, for example, certain limitations as to their safety.

For example, it happens that an intruder tries to open the door in the safety position by simply pulling the door open so that the safety component comes loose from its attachment in the frame or alternatively in the door.

Furthermore, similar safety chains or safety braces can be mechanically damaged, for example by means of a bolt clipper, so that the safety component breaks.

Such attempted burglary or the like can take place, for instance, in connection with the door being opened in the safety position for ventilation purposes or for some other reason.

Another problem of today's safety components is that they normally also obstruct people who rightfully are authorised to open the door from the outside. This situation may arise, for instance, when a distressed or injured person is to be rescued.

A further problem of these safety components is that they are bulky and take up a substantial part of the surface on the inside of the door.

This means that several requirements can be placed on a device with a safety function. The device should, for example, have good operability with appropriate safety. A further requirement is that it should be possible to authorise people to operate the safety lock from the outside of the door. Moreover the device should have a small number of components and the mounting thereof should be easy. For example, the device should be applicable to most types of door, without necessitating considerable constructional changes. Henceforth the device should be adjustable to client and market requirements.

### SUMMARY OF THE INVENTION

An object of the present invention is to provide a safety lock which satisfies one or more of the above requirements. A further object of the present invention is to provide a safety lock which solves one or more of the above problems.

This is achieved by the following features the safety lock stated by way of introduction and comprising said locking means constitutes both lock and limitation for the opening movement of the door,

the end part of the locking means, when the locking means is in its safety position, is movable only a limited distance perpendicular to the plane of the door, the end part of said locking means engaging an abutment means arranged adjacent to the frame and thus limiting the opening movement of the door;

the end part of the locking means, when the locking means is in its locked position, is rigidly connected to the remaining part of the locking means and overlaps said stop shoulder;

said locking means, in its open position, is moved away from its position overlapping said stop shoulder.

When the safety lock is mounted in the place intended, the lock is operable between a locked position, a safety position and an open position. In the safety position the end part of the locking means and the abutment means of the frame are thus connected to each other so that the opening movement of the door is limited in a suitable manner. The safety lock does not have to, for instance, be fastened in a plane that coincides with the door plane and a corresponding plane of the frame.

Opening member relates mainly to doors and windows, but may, of course, also relate to other objects that limit access, such as gates, front doors and other devices limiting passage.

Said locking means is preferably angleable and simultaneously connectible to the abutment means to limit the opening movement of the door. Thus the locking means is angled in the opening movement which provides said interconnection.

The locking means is advantageously tiltable relative to the frame when the locking means is in its safety position, the end part of said locking means being movable perpendicular to the plane of the door, which means that, when the door leaves its closed position, the end part of the locking means engages said abutment means to limit the opening movement of the door. When the door is opened with the locking means in the safety position, the locking means will be moved so as to abut against the frame, the locking means suitably being moved, and said engagement can take place between the end part of the locking means and the abutment means. Consequently the safety lock will be operable and obtain a good safety function.

Said locking means is suitably a latch bolt, and said stop shoulder is suitably a recess in the frame, such as a lock plate.

The abutment means is preferably a hook means which allows reliable engagement with the locking means in its safety position.

The abutment means can alternatively be, for example, a recess to engage with a complementary locking means.

The angleability of the locking means is advantageously blocked by a rigid blocking element bridging the parts of the locking means, when the latch bolt is in its locked position. This ensures a robust and reliable safety lock.

The end part of the locking means is preferably provided with a recess. This results in good contectibility to the abutment means to limit the opening movement of the door in a reliable manner.

The locking means is suitably telescopically extensible and spring loaded against its short position. As a result, the door can be affected by spring action towards the frame, and the distance of the opening movement can be adjusted.

The blocking element and the locking means are advantageously separately operable. This makes it possible to operate the elements each separately from the inside and/or the outside of the door.

The blocking element and the locking means are advantageously simultaneously operable. As a result, the elements can be operated together from the outside and/or the inside of the door.

The locking means and/or the blocking element are preferably operable by a key. This gives the advantage that, for example, a person in distress who is positioned inside the door can be rescued by an authorised person from the outside although the safety lock is in its safety position.

By key is in the first place meant a mechanical key means, but a key may also comprise cards (included in a card-reading system), key codes or other authorisation means, such as fingerprint patterns for operation of locking means and blocking element.

The safety lock can be manually operable from the inside of the door. This enables smooth and easy handling of the blocking element and/or the locking means.

### BRIEF DESCRIPTION OF THE DRAWINGS

The invention will now be described with reference to the accompanying drawings which by way of example illustrate currently preferred embodiments of the present invention.

FIG. 1 illustrates schematically, in the form of an exploded view, parts of a safety lock according to a first embodiment of the invention.

FIG. 2a is a schematic view, partly in cross-section, of a safety lock with a locking means in an open position, according to the first embodiment of the invention.

FIG. 2b illustrates schematically the safety lock in FIG. 2a, in a locked position.

FIG. 3a illustrates schematically the safety lock in FIG. 2a, in a first position in a safety position.

FIG. 3b illustrates schematically the safety lock in FIG. 2a, in a second position in the safety position.

FIG. 3c illustrates schematically the safety lock in FIG. 2a, in a third position in the safety position.

FIG. 4a is a schematic view, in cross-section seen from above, of the safety lock with a locking means in an open position, according to FIG. 2a.

FIG. 4b illustrates schematically the safety lock in FIG. 4a, in the first position in the safety position.

FIG. 4c illustrates schematically the safety lock in FIG. 4a, in the second position in the safety position.

FIG. 4d illustrates schematically the safety lock in FIG. 4a, in the third position in the safety position.

FIG. 5 illustrates schematically a safety lock, with a locking means in an open position, according to a second embodiment of the invention.

### DESCRIPTION OF PREFERRED EMBODIMENTS

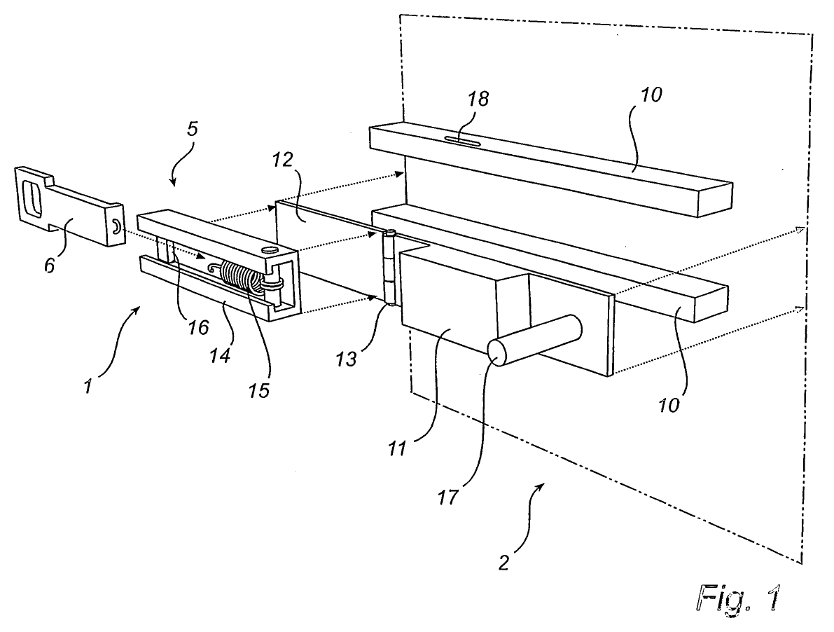

FIG. 1 shows parts of a safety lock 1 according to a first, currently preferred embodiment of the present invention. The safety lock 1, which is mounted on, or alternatively in, an opening member 2, such as a door or alternatively a window, comprises a locking means 5, such as a latch bolt.

The safety lock according to the present invention preferably consists mainly of rigid materials, preferably metal. The safety lock is, for example, mountable on most types of doors, for instance apartment doors, hotel doors and storeroom doors, but of course also doors in residential blocks, homes designed for the elderly and flats for people receiving care.

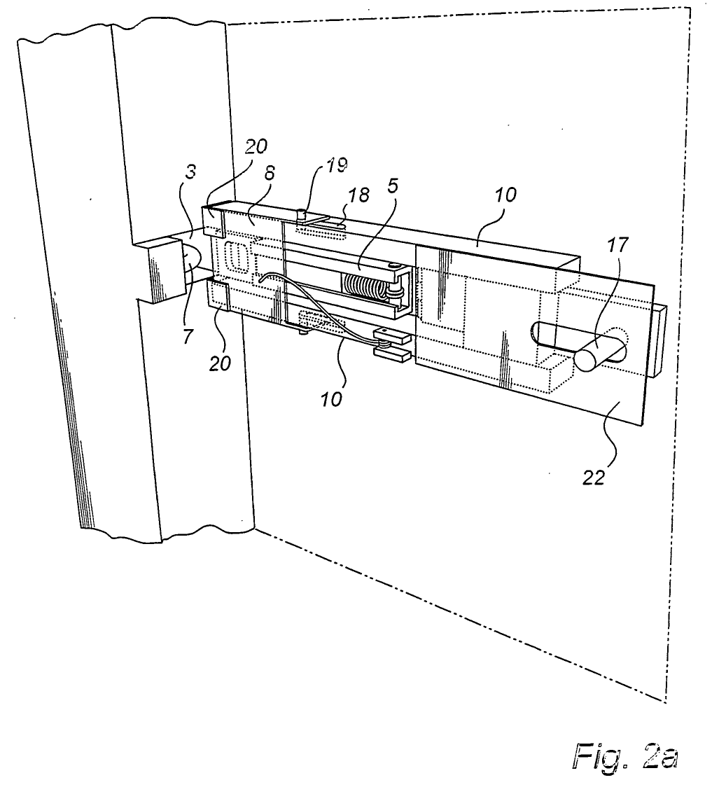

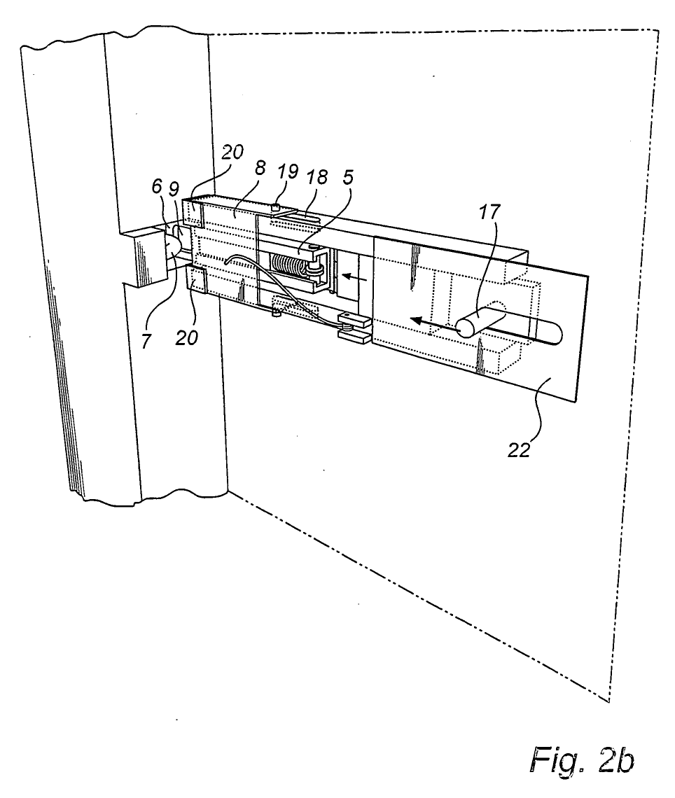

FIG. 2a shows the safety lock according to the first embodiment mounted on the inside of a door 2. The door is at one lateral edge hingedly attached to a frame 4. The frame 4 has at its opposite side preferably a frame recess 3, in which a lock plate is suitably arranged. Furthermore the frame 4 has an abutment means 7, which preferably is a hook means.

Referring once more to FIG. 1, the latch bolt 5 is suitably slidably arranged in two parallel bars 10 which are mounted preferably horizontally on the door 2. The latch bolt 5 is thus movable essentially in the horizontal direction along the plane of the door 2. The latch bolt 5 suitably consists of an operating portion 11 which is slidably connected to the bars 10 and a hinged portion 12. The operating portion 11 is hingedly connected to the portion 12 by means of a lock hinge 1,. The portion 12 carries a flanged rail 14 which partially surrounds an end part 6 of the latch bolt 5. The end part 6 is slidably arranged in the flanged rail 14. A tension spring 15 is attached to one end of the flanged rail 14 and is also connected to the end part 6 of the latch bolt. A slide stop 16 for the end part 6 of the latch bolt is arranged at the other end of the flanged rail and limits the movement of the end part 6 relative to the flanged rail 14. Moreover the end part 6 of the locking means is provided with a recess 9 which is adapted to engage the hook means 7 of the frame 4.

The operating portion 11 is at its free end provided with an operating means 17 to operate the sliding movement of the latch bolt 5 in the bars 10. Further the bars 10 have two locking grooves 18 arranged on opposite horizontal bar sides.

With reference once more to FIG. 2a, the safety lock 1 has a blocking element 8 which is movable to and from a position in which it covers parts of the bars 10 and the latch bolt 5. The blocking element 8 is at its one end slidably guided in the locking grooves 18 by means of blocking pins 19. The blocking element 8 is at its other end insertable under two grip portions 20 which are arranged at the short sides of the bars 10, see FIG. 2a. The lower of the two bars 10 has an engagement spring 21 whose free end exerts pressure on a surface portion of the blocking element 8. The bars 10 are at least partially covered by a cover plate 22. The cover plate 22 is preferably provided with an adjusted recess which allows the movements of the operating means.

Referring once more to FIG. 2a, which shows the frame 4 with the frame recess 3, which is adjusted so that the end part 6 of the locking means can be inserted into the same. The hook means 7 is arranged, preferably with its free end directed to the outside of the door and curved inwards to the frame recess, to be connected to the recess 9 of the latch bolt 5.

With reference to FIGS. 2a-b, 3a-c and 4a-d, the function of the safety lock will be described in the following.

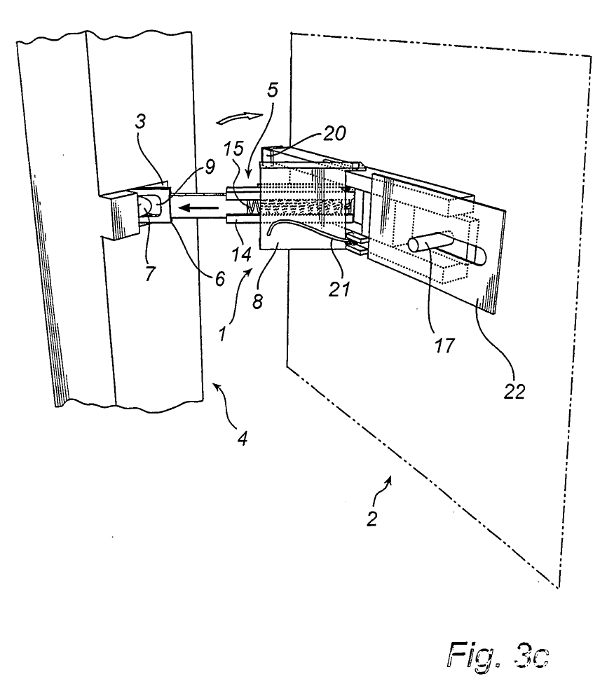

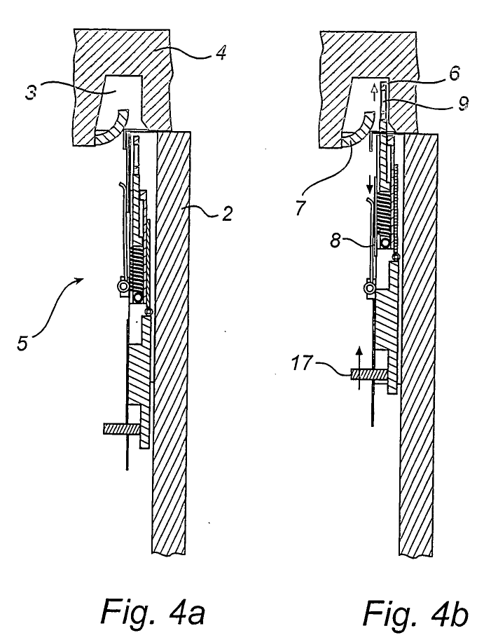

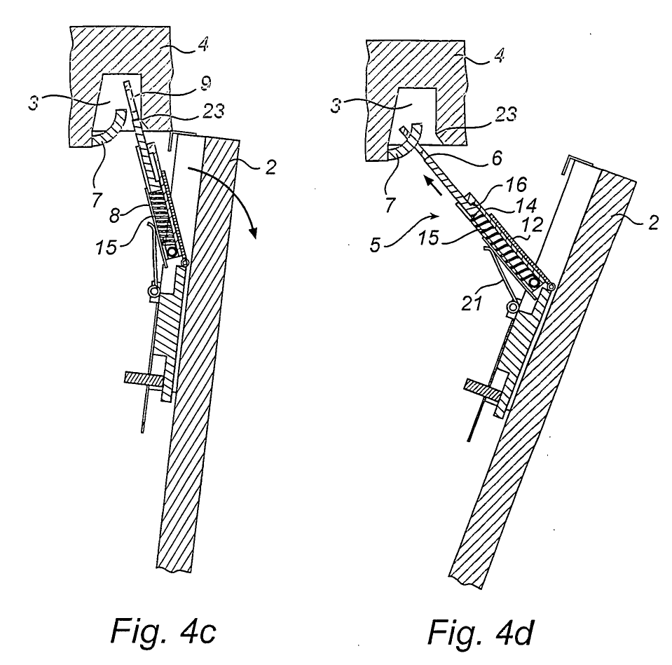

FIGS. 2a and 4a illustrate the safety lock with the latch bolt 5 in an open position, which makes it possible to open the door, in the usual way, without a limited opening movement. The open position means that the latch bolt is guided, by the operating means 17, in the bars 10, away from the lock plate 3. Thus the end part 6 of the latch bolt runs freely without being affected by the frame recess 3.

FIG. 2b illustrates the safety lock with the latch bolt 5 in a locked position, which means that the door is locked in the usual known manner. The locked position means that the end part 6 of the latch bolt is inserted into the frame recess 3, which in this position prevents the door from being opened.

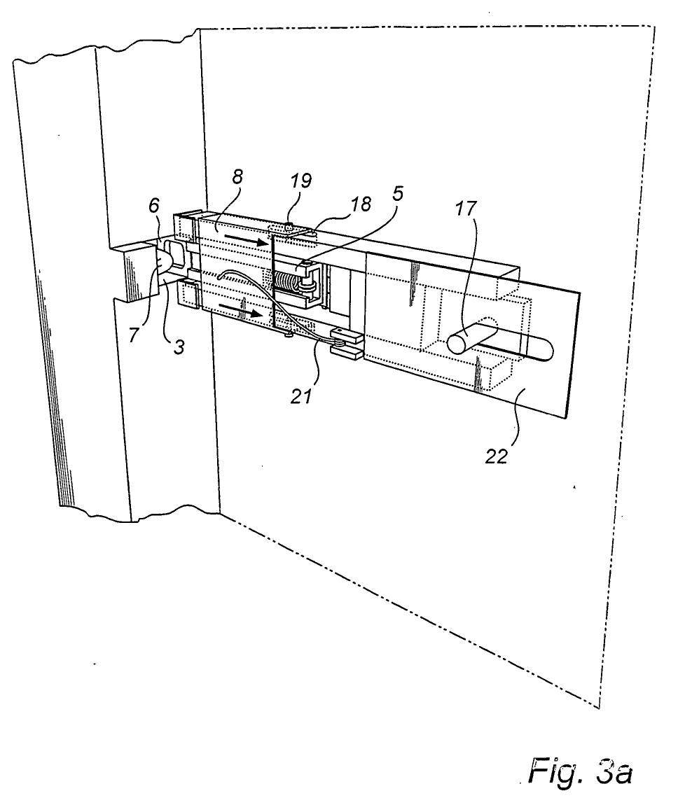

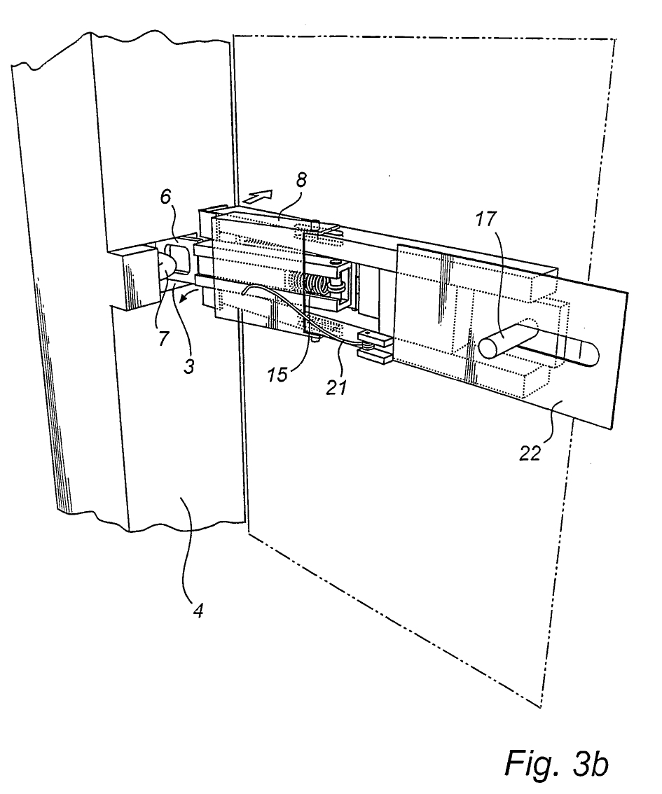

FIGS. 3a and 4b illustrate the safety lock with the latch bolt 5 in a safety position in a first position. The safety position means that the door 2 can be opened only a limited distance. In FIG. 3a, the arrows indicate a movement of the blocking element 8. The movement of the blocking element 8 from a blocked position to a hinged safety position is effected by the blocking element being moved in the horizontal direction, away from the frame, along the plane of the door 2. The blocking pins 19 at one of the blocking element 8 slide in the blocking grooves 18 in the above direction. At the other end of the blocking element 8, its edge portions leave the two grip portions 20 so that the blocking element 8 can pivot outwards and be angled from the plane of the door 2.

FIGS. 3b and 4c illustrate the safety lock with the latch bolt 5 in the safety position in a second position in the course of a limited opening movement. In FIG. 3b, the unfilled arrow indicates the opening movement of the door 2. The filled arrow indicates the angling of the latch bolt 5 and the blocking element 8 relative to the plane of the door 2. As is especially shown in FIG. 4c, the opening movement of the door means that the latch bolt 5 with its end part 6 preferably will abut against the frame recess 3, in this position. The opening movement of the door means that an engagement force causes the latch bolt 5 and the blocking element 8 to hingedly pivot outwards relative to the plane of the door 2.

FIGS. 3c and 4d illustrate the safety lock with the latch bolt 5 in the safety position in a third position in the course of a limited opening movement. Compared with the above-described second position, the following happens in the course of a continued limited opening movement. As described above the locking means 5 tilts about the frame 4 and in the frame recess 3 causes counterclockwise pivoting about the tilting point 23. The end part 6 of the locking means 5 is moved and pivoted inwards to the hook means 7. The hook means 7 thus receives the latch bolt 5 in the recess 9, whereby inter-connection occurs while the limited opening movement is completed, see FIG. 4d.

The connected latch bolt 5 is extensible in its longitudinal direction by the end part 6 being slidably arranged in the flanged rail 14. When the door is opened to its third position, the end part 6 is pulled out relative to the flanged rail 14 and can be pulled out a limited distance against the action of the tension spring 15. This pull-out distance of the latch bolt 5 is limited by the slide stop 16, which is seen in FIG. 4d. The safety lock thus obtains appropriate safety and good burglary protection.

With reference once more to FIGS. 4d and 4c, which illustrate when the door is again to be closed from a limitedly open door 2 in the safety position. The door can, in a closing movement, at least to some extent, be pulled inwards by means of the tension spring 15 towards the door frame from the partially open position in position three to position two when the end part 6 of the latch bolt is pulled into the flanged rail 14. Furthermore the engagement spring 21 can, in the closing movement, actuate the blocking element 8, at least to some extent, to pivot inwards once more to a position which is parallel to the door plane to a corresponding first position in the safety position.

The blocking element 8 can, in this position in the safety position, be moved if the user intends to “lock the door” by the blocking element 8 being inserted once more in the grip portion 20, which prevents the end part 6 of the latch bolt from pivoting outwards relative to the door plane.

If the user intends to open the door and perform a complete opening movement from the first position in the safety position, the latch bolt 5 is moved instead. The latch bolt is then moved from its position overlapping the frame recess 3. When the latch bolt has left the frame recess 3 and when the end part 6 of the latch bolt is not connected to the hook means 7, the door 2 can therefore be given an entire opening movement in a generally known manner.

The safety lock is preferably operable by a key from the outside of the door. The operability comprises, in the first place, controlling of the latch bolt between the open position and the locked position and, in the second place, suitably also the control of the safety position. This key function is conveniently integrated with the latch bolt 5 and the blocking element 8.

The safety lock is preferably operable from the inside of the door. In the first place, the lock is operable by a key between the different operating positions of the lock as described above. In the second place, the safety lock is, for instance, also manually operable to handle the different positions of the lock, as described above.

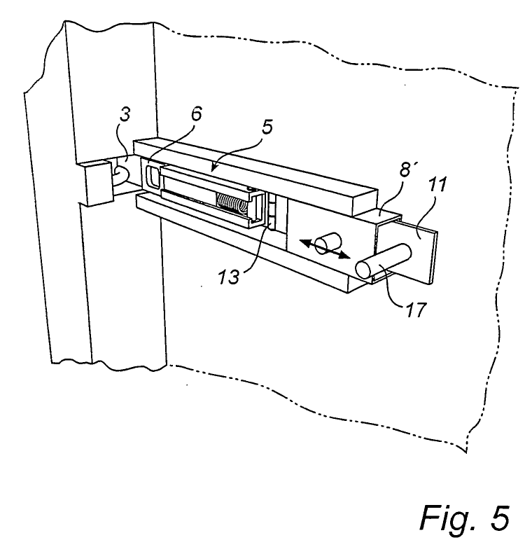

FIG. 5 illustrates the present invention according to a second embodiment. The definitions, components and variations of the previously described first embodiment, which are not directly mentioned below in connection with the second embodiment, are similar to the second embodiment, the description of these being omitted with reference to the above description. The blocking element according to the second embodiment consists of a sleeve-like blocking element referred to as a ratchet sleeve 8′. The ratchet sleeve 8′, which can be slidably moved along the latch bolt, has operating positions corresponding to those described above. The safety lock is in FIG. 5 in an open position with the latch bolt in an open position and with the ratchet sleeve 8′ in an angleable position. To reach the safety position, the end part 6 of the latch bolt is moved into the frame recess 3 in the manner described above. To reach the locked position, the ratchet sleeve 8′ is also moved over the latch bolt 5 towards the frame 4, thereby inhibiting the angleability of the latch bolt. The safety position means that the ratchet sleeve 8′ rigidly connects the hinge of the latch bolt, without pivotability. With reference once more to FIG. 5, the latch bolt and the ratchet sleeve can be partially moved simultaneously when operating the operating means 17. In this operation, the latch bolt 5 is inserted into the frame recess 3, and the ratchet sleeve allows the latch bolt to be angled from the plane of the door according to the described safety position.

It will be appreciated that the above-described embodiment of the invention can be modified and varied by a person skilled in the art without departing from the inventive idea as defined in the claims. For example, the above-described safety lock can with relatively simple means be adjusted to constitute a safety lock for a window which is intended, for instance, for a controllable ventilating position in the described safety position.

Moreover, the length of the pull-out movement of the latch bolt can be controllable as can consequently also the limited opening movement of the door by a control means adjusting the length thereof. Of course, said operating means can instead be a box case for operating the lock, in a generally known manner, using a key. Moreover, this box case can also operate said blocking element. The safety lock can also be adjusted so that the door can be opened either inwards or outwards, or alternatively a combination of both functions. The locking means can also be replaced by a lock lever which is lowered, instead of being axially moved into the frame recess. Moreover the lock lever in the safety lock has the other properties as described above.

A further alternative of the safety lock is that the pivotability of the locking means is replaced by a means which performs a sliding movement essentially orthogonally to the plane of the door. This sliding movement has a stop element which at its one end limits the opening movement of the door.

Moreover, the safety lock may consist of different materials, such as plastic or some other material exhibiting the properties in terms of materials technology that are required according to the purpose of the invention.

The safety lock round the door opening can further be adjusted so as to minimise the risk of injuries caused by squeezing. To this end, for instance protective covers can be arranged adjacent to the safety lock.

The cooperating means, i.e. the locking means 5 and the abutment means 7, can further be brought together by means of, for example, splines, key joints, mechanical joints, press fits, screw joints and shrink fits. The safety lock can also be adjusted so that the latch bolt and the other associated components are mainly arranged adjacent to the frame 4 instead of the door 2.

The safety lock can further constitute merely an extra lock supplementing other door operation of open and closed position.

Furthermore the safety lock can be adjusted so that the locking means 5 can be operated by a key from the outside of the door, also when a key is inserted in the lock on the inside of the door.

The safety lock may further consist of several parts, either as separate or as composite components. In the contrary case, the safety lock may consist of several integrated parts.

### REFERENCE NUMERALS

1. safety lock

2. opening member; door; window

3. stop shoulder; frame recess; lock plate

4. frame

5. locking means; latch bolt

6. end part of locking means

7. abutment means; hook means

8. blocking element; 8′ ratchet sleeve

9. recess in locking means

10. bar for locking means

11. operating portion

12. hinged portion

13. lock hinge

14. flanged rail

15. tension spring

16. slide stop

17. operating means

18. locking groove

19. blocking pins

20. grip portion

21. engagement spring

22. cover plate

23. tilting point

1-16. (canceled)

17. A safety lock (1) for opening members (2), such as doors and windows, comprising a stop shoulder (3) arranged adjacent to the frame (4) of the door, a locking means (5) arranged adjacent to the door (2) and movable along the plane of the door, and movingly overlapping the stop shoulder (3), which locking means (5) is operable-at least from the inside of the door (2), said locking means (5) having a locked position, a safety position and an open position,
characterised in that
said locking means (5) constitutes both lock and limitation for the opening movement of the door,
the end part (6) of the locking means, when the locking means (5) is in its safety position, is movable a limited distance perpendicular to the plane of the door, the end part (6) of said locking means engaging an abutment means (7) arranged adjacent to the frame (4) and thus limiting the opening movement of the door,
the end part (6) of the locking means, when the locking means (5) is in its locked position, is rigidly connected to the remaining part of the locking means (5) and overlaps said stop shoulder,
said locking means (5), in its open position, is moved away from its position overlapping said stop shoulder (3).

18. A safety lock (1) as claimed in claim 17, wherein said locking means (5) is angleable and thus connectible to the abutment means (7) to limit the opening movement of the door.

19. A safety lock (1) as claimed in claim 17 or 18, wherein the locking means (5) is tiltable adjacent to the frame (4) when the locking means (5) is in its safety position,
the end part (6) of said locking means being movable perpendicular to the plane of the door (2), which means that, when the door (2) leaves its closed position, the end part (6) of the locking means engages said abutment means (7) to limit the opening movement of the door (2).

20. A safety lock (1) as claimed in claim 17, wherein said locking means is a latch bolt (5).

21. A safety lock (1) as claimed in claim 17, wherein the stop shoulder is a recess (3) in the frame.

22. A safety lock (1) as claimed in claim 17, wherein the stop shoulder is a lock plate (3).

23. A safety lock (1) as claimed in claim 17, wherein the abutment means is a hook means (7).

24. A safety lock (1) as claimed in claim 17, wherein the abutment means (7) is a recess.

25. A safety lock (1) as claimed in claim 17, wherein the angleability of said locking means (5) is blocked by a bridging rigid blocking element (8; 8′) when the locking means (5) is in its locked position.

26. A safety lock (1) as claimed in claim 25, wherein the blocking element (8′) is moved relative to the locking means (5) towards the frame (4) so as to inhibit the angleability of the locking means (5) by rigidly connecting the hinge thereof.

27. A safety lock (1) as claimed in claim 17, wherein the end part (6) of the locking means is provided with a recess (9).

28. A safety lock (1) as claimed in claim 17, wherein the locking means (5) is telescopically extensible and spring loaded against its short position.

29. A safety lock (1) as claimed in claim 17, wherein the blocking element (8; 8′) and the locking means (5) are separately operable.

30. A safety lock (1) as claimed in claim 17, wherein the blocking element (8; 8′) and the locking means (5) are simultaneously operable.

31. A safety lock (1) as claimed in claim 17, wherein the locking means (5) is operable by a key.

32. A safety lock (1) as claimed in claim 17, wherein the blocking element (8; 8′) is operable by a key.

33. A safety lock (1) as claimed in claim 17, wherein the safety lock (1) is manually operable from the inside of the door (2).
